(19) United States
(12) Patent Application Publication
(10) Pub. No.: US 2009/0313841 A1
(43) Pub. Date: Dec. 24, 2009

(54) Template kit for scribing openings for electrical junction boxes, box covers, and light fixtures

(76) Inventor: Lawrence Calleros, Huntington Beach, CA (US)

Correspondence Address: LAWRENCE CALLEROS, 1321 ARCH LANE, HUNTINGTON BEACH, CA, 92648, US

(21) Appl. No.: 12/316,609

(22) Filed: Dec. 16, 2008

Related U.S. Application Data
(60) Provisional application No. 61/008,104, filed on Dec. 19, 2007.

(51) Int. Cl. G01B 1/00; G01B 3/14; G01D 21/00

(52) U.S. Cl. 33/528; 33/563; 33/645

(57) ABSTRACT

A template kit which consists of several different templates that can be used to mark or scribe openings for the installation of electrical boxes, box covers, and light fixtures in walls, cabinets, partitions, ceiling tiles, or any other flat surface. A generic version of a template in this kit is template 10. Each template in this kit will be made of a flat, transparent, and lightweight material 14 preferably plastic or Plexiglas. The thickness 12 of each template is approximately 3/32″. Each template will have either a “cross hair” or “dot” 16 marked on it to aid in aligning the template on a flat surface. The opening for the electrical junction box or box cover is marked on a surface around the periphery of the template. The periphery of each template in this kit are manufactured to a specific dimension to best match it to one of the many different shapes of electrical boxes, box covers, and light fixtures.

### BACKGROUND OF THE INVENTION

1. Field of the Invention

This invention relates to the construction of buildings and the installation of electrical equipment. More specifically, but not by way of limitation, the templates in this invention are used for scribing or marking the openings in walls, cabinets, ceiling tiles, and partitions for electrical junction boxes, box covers, and light fixtures.

2. Priority

This application claims priority of provisional application No. 61/008,104, entitled “TEMPLATE KIT FOR SCRIBING OPENINGS FOR ELECTRICAL JUNCTION BOXES AND BOX COVERS”, filed on Dec. 19, 2007.

3. Description of the Prior Art

There are many different shapes and sizes of electrical junction boxes, box covers, and light fixtures used for electrical installations. Electrical box covers are often called “plaster rings”. It is important for the openings cut out in walls, cabinets, ceiling tiles, and partitions to accurately match the electrical box, box cover, or light fixture to be installed. If the openings are cut excessively large, there will be cracks and openings exposed around the junction box, box cover, or light fixture opening after installation. Excessively large cracks and openings will require additional work and expense to repair because an electrical face plate or trim “ring” will not cover the hole. An opening cut out too large in a wall for installing an electrical “cut in” junction box will degrade the integrity of the installation because “cut in” boxes are supported solely by the wall itself. Openings cut out too large in cabinets are very expensive and time consuming to repair, especially if damage is done to an existing and finished cabinet. When multiple electrical junction boxes or lights are installed near each other, it is very important for them to be at the same level or in a straight line for aesthetic purposes. Therefore, having a means for marking accurate and level openings for electrical junction boxes, box covers, and lights will save time, and avoid costly repairs.

A problem with many templates is they are either too bulky or delicate to carry around every day in a tool pouch. A Paper template such as the one usually supplied with “cut in” boxes are not durable and tend to give way when contact is made along the edges with a pencil. An example of a cut in box is U.S. Pat. No. 4,332,330. Templates with bubble type levels are limited to their applications, and are subject to damaged if a metal hand tool simply makes undesirable contact with the bubble level. An example of a template with a bubble level is U.S. Pat. No. 6,434,848. Templates that are designed to both measure and outline the location of an electrical junction box tend to be too bulky to carry around in a tool pouch every day. An example of a template used to measure and outline the location of an electrical box is U.S. Pat. No. 5,860,219. Because of the many problems, templates are often kept somewhere far away from the work area and are not readily available for immediate use.

The ability to align a template accurately for a cutout usually requires drawing alignment markings on the surface with a pencil or marker prior to placing the template on the surface. It is often necessary to draw alignment markings on the surface long enough so they will be exposed outside the perimeter of the template. Then the template is placed directly over the markings for proper alignment. A pencil or marker is used to mark the surface around the perimeter of the template. The template is then removed, and the desired shape of the hole to be cut out is left on the surface. The problem with drawing alignment marks on a surface longer in diameter than the template is that some of the marks will be left on the surface after the hole is cut out. The process of eliminating exposed markings left on a surface may damage the existing surface. Therefore it is desirable to create a template that will fully encompass the alignment markings to avoid damaging the surface.

Template designers often emphasize how their templates can be used for outlining electrical junction boxes, but it's equally if not more important to be able to outline electrical box covers and light fixture openings. To enable a craftsman to accurately outline many different openings of electrical junction boxes, box covers, and light fixtures it is necessary to invent a complete kit of several individual templates to match many of the most commonly used electrical junction boxes, box covers, and light fixtures used in the electrical industry.

### SUMMARY OF THE INVENTION

A goal of this invention is to create a template kit to outline many of the most commonly used electrical junction boxes, box covers, and light fixtures used in the electrical industry. Each template in this kit is manufactured to a specific dimension to define the shape of the opening to be cut out.

Another goal of this invention is to create a template that is easy to use without causing damage to an existing surface. The templates in this invention are made of a transparent material with a “cross hair” or “dot” marked on them for quick and accurate alignment. Because the templates in this invention are transparent, alignment markings on a surface no longer have to be made longer in diameter than the template. The goal of cutting out the desired hole without leaving any alignment markings on the surface can now be achieved because the periphery of a transparent template can fully encompass the alignment marks on a surface.

A further goal of this invention is to create a template that is durable. A template will most likely be carried in a tool pouch where it is always subject to undesirable contact with metal hand tools. Each template in this invention has either a “cross hair” or “dot” marked on it for alignment, thus eliminating the need to mount a bubble level on it that can be broken.

It is desirable for a template to be easily held in place to mark the surface around the perimeter of it. All of the templates in this invention are preferably made of a 3/32″ thick, flat and transparent plastic or Plexiglas material. A 3/32″ thick edge will allow a user to easily mark a surface around the perimeter of the template with a pencil or other instrument.

The most important goal of this invention is to manufacture a template would most likely be readily available for immediate use. A busy craftsman will usually carry a limited number of hand tools in a tool pouch to keep it as light as possible. The tool pouch is then worn on his body. If a template is too bulky or delicate to be carried around daily in a tool pouch, it most likely will end up on a shelf collecting dust somewhere far away from the work area. To solve that problem, each template in this invention is manufactured physically as small as possible for the application needed. The most commonly used templates in this invention are so small and thin that they can easily be carried in a wallet or shirt pocket.

### BRIEF DESCRIPTION OF THE DRAWINGS

FIG. 1 is a typical side view of all the templates in this invention.

FIG. 2 is a three dimensional view showing the front face of a template for a single gang box cover.

FIG. 3 is a frontal view showing the face of a template for a 3/0 box cover.

FIG. 4 is a frontal view of the face of a template for a 2-gang box cover.

FIG. 5 is a frontal view of showing the face of a template for a 3-gang box cover.

FIG. 6 is a frontal view showing the face of a template for a “cut in” box.

FIG. 7 is a frontal view showing the face of a template for a “handy” box.

FIG. 8 is a frontal view showing the face of a template for a 4″ round junction box.

FIG. 9 is a frontal view showing the face of a template for a 4″ octagon junction box.

FIG. 10 is a frontal view showing the face of a template for a 4″ square junction box.

FIG. 11 is a frontal view showing the face of a template for a 4 11/16″ square junction box.

FIG. 12 is a frontal view showing the face of a template for a 5¼″ square recessed light fixture opening.

FIG. 13 is a frontal view showing the face of a template for an 8½″ square recessed light fixture opening.

FIG. 14 is a frontal view showing the face of a template for a 4½″×13½″ exit light fixture opening.

FIG. 15 is a view showing the typical manner of how a craftsman would use a template to mark or scribe a surface.

### DETAILED DESCRIPTION OF THE PREFERRED EMBODIMENT

The template 10 comprises the preferred embodiment of all the templates in this invention. Template 10 is a flat plate of transparent and lightweight material 14 and is preferably made of plastic or Plexiglas. Template 10 is approximately 3/32″ thick 12. Each template in this invention will have either a “cross hair” or “dot” 16 marked on it to aid in aligning the template on the desired location. All of the templates in this invention are designed to be held in position on a surface by hand. A pencil or other instrument it used to mark the surface around the periphery of the template. The template is then removed from the surface and tools such as a drywall saw, jig saw, rotozip, or hole saw are used to cut out the desired opening. Although every template in this invention comprises the same embodiments of template 10, it's important to note the periphery of each template in this kit is manufactured to a specific dimension.

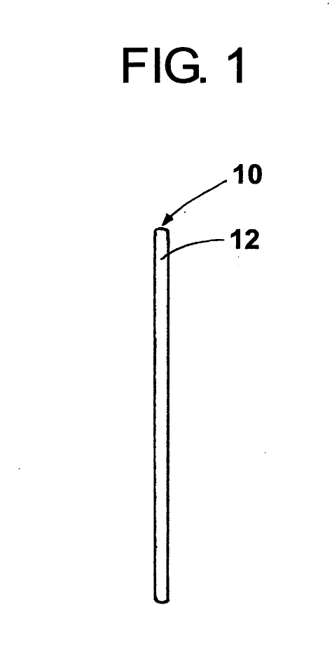

FIG. 1 is a typical side view of all the templates in this invention. All of the templates are preferably made of a flat and transparent plastic or Plexiglas material 14 and are approximately 3/32″ thick 12.

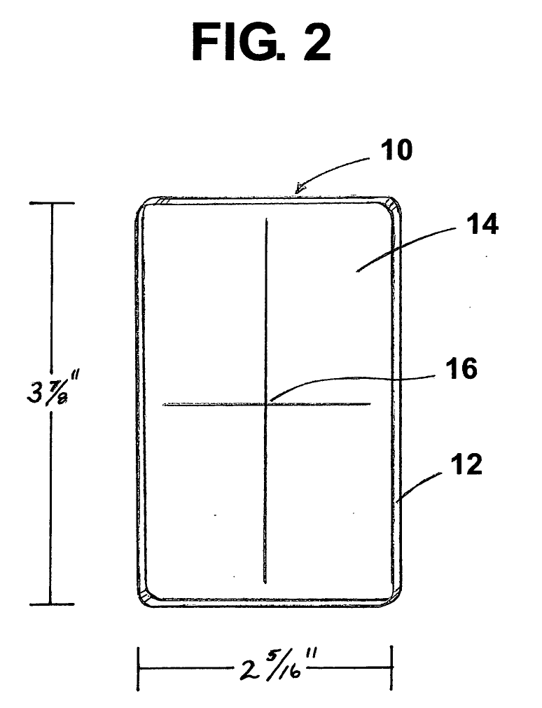

FIG. 2 is a three dimensional view showing the front face of a template for a single gang box cover. The overall dimension of the template is 3⅞″ tall×2 5/16″ wide× 3/32″ thick 12. It is preferably manufactured from a flat sheet of transparent plastic or Plexiglas material 14. It has a cross hair 16 marked on the template to aid in aligning the template on the surface to be cut out.

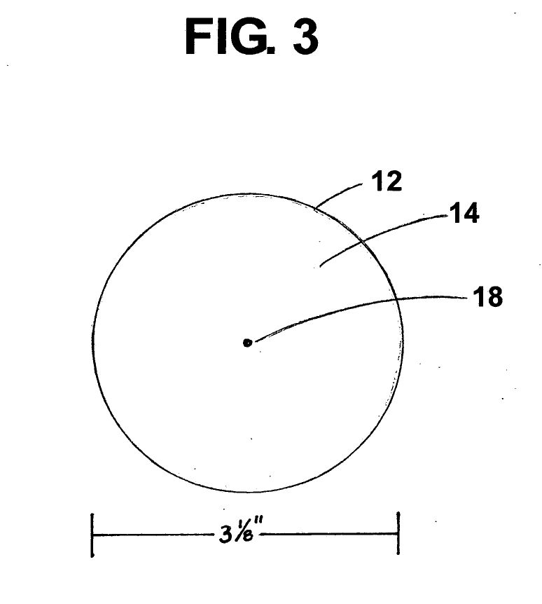

FIG. 3 is a frontal view showing the face of a template for a 3/0 box cover. The overall dimension of the template is 3⅛″ diameter× 3/32″ thick 12. It is preferably manufactured from a flat sheet of transparent plastic or Plexiglas material 14. It has a dot 18 marked on the template to aid in aligning the template on the surface to be cut out.

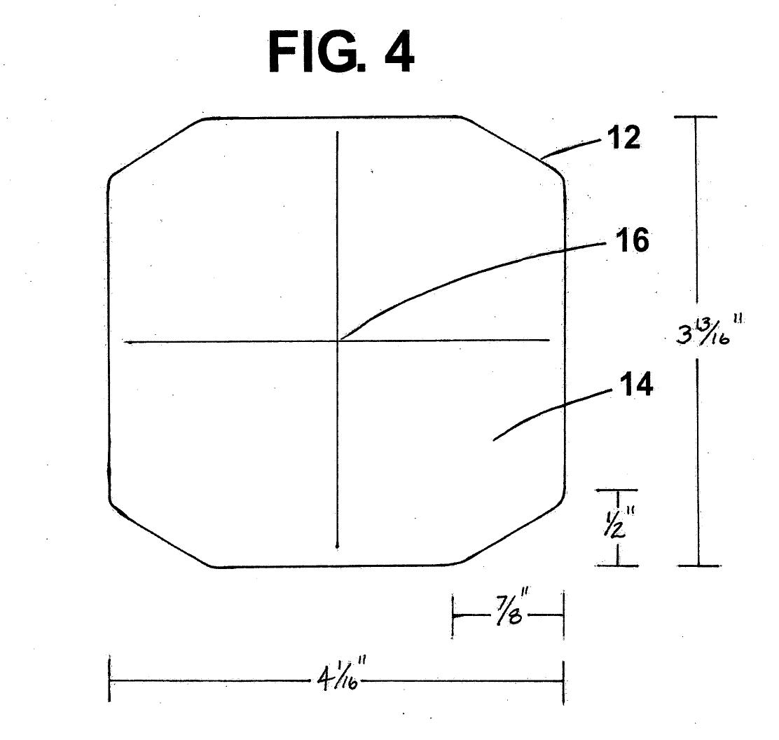

FIG. 4 is a frontal view of the face of a template for a 2-gang box cover. The overall dimension of the template is 3 13/16″ tall×4 1/16″ wide× 3/32″ thick 12. It is preferably manufactured from a flat sheet 14 of transparent plastic or Plexiglas material. It has a cross hair 16 marked on the template to aid in aligning the template on the surface to be cut out.

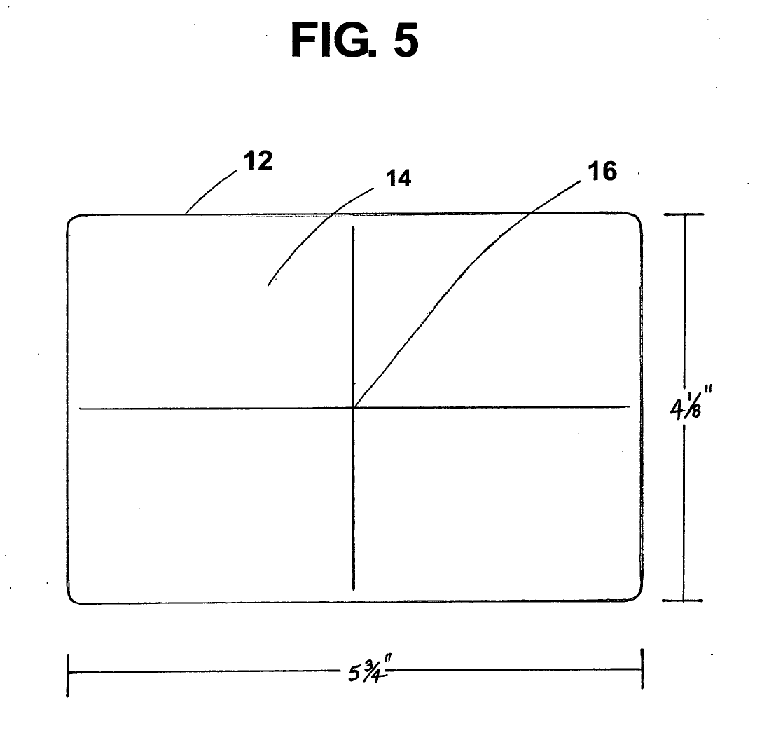

FIG. 5 is a frontal view of showing the face of a template for a 3-gang box cover. The overall dimension of the template is 4⅛″ tall×5¾″ wide× 3/32″ thick 12. It is preferably manufactured from a flat sheet 14 of transparent plastic or Plexiglas material. It has a cross hair 16 marked on the template to aid in aligning the template on the surface to be cut out.

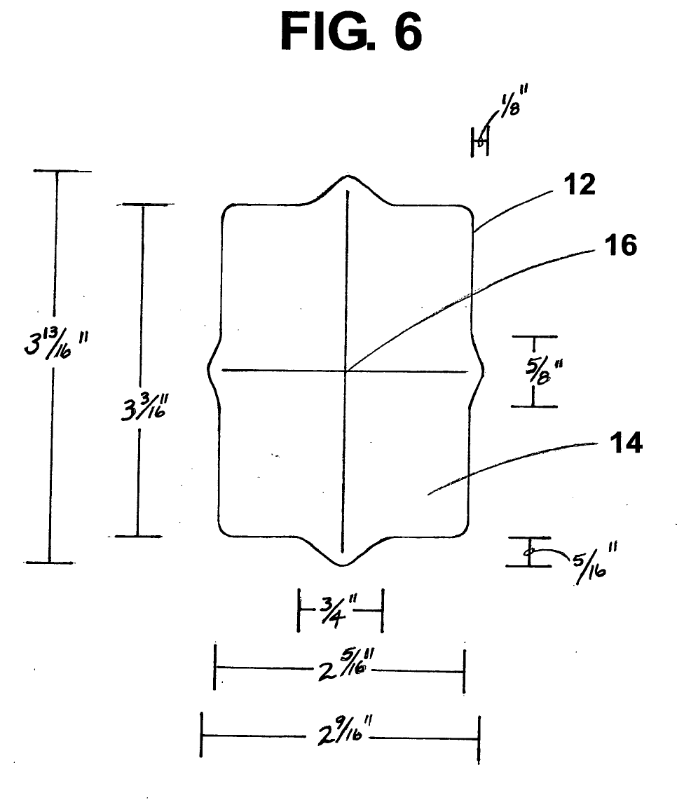

FIG. 6 is a frontal view showing the face of a template for a “cut in” box. The overall dimension of the template is 3 13/16″ tall×2 9/16″ wide× 3/32″ thick 12. It is preferably manufactured from a flat sheet 14 of transparent plastic or Plexiglas material. It has a cross hair 16 marked on the template to aid in aligning the template on the surface to be cut out.

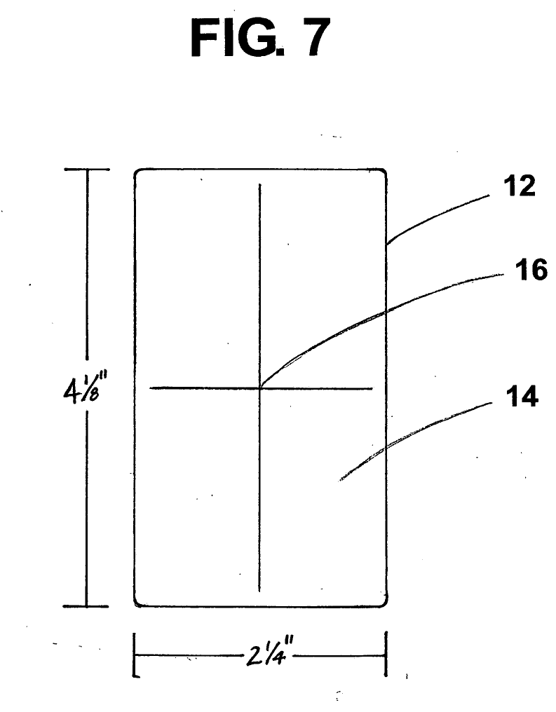

FIG. 7 is a frontal view showing the face of a template for a “handy box”. The overall dimension of the template is 4⅛″ tall×2¼″ wide× 3/32″ thick 12. It is preferably manufactured from a flat sheet 14 of transparent plastic or Plexiglas material. It has a cross hair 16 marked on the template to aid in aligning the template on the surface to be cut out.

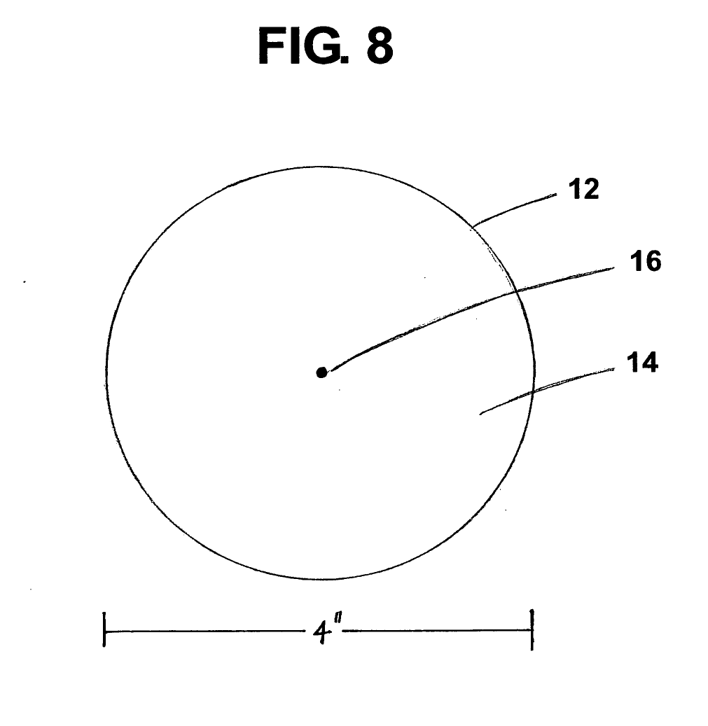

FIG. 8 is a frontal view showing the face of a template for a 4″ round junction box. The overall dimension of the template is 4″ diameter× 3/32″ thick 12. It is preferably manufactured from a flat sheet 14 of transparent plastic or Plexiglas material. It has a dot 18 marked on the template to aid in aligning the template on the surface to be cut out.

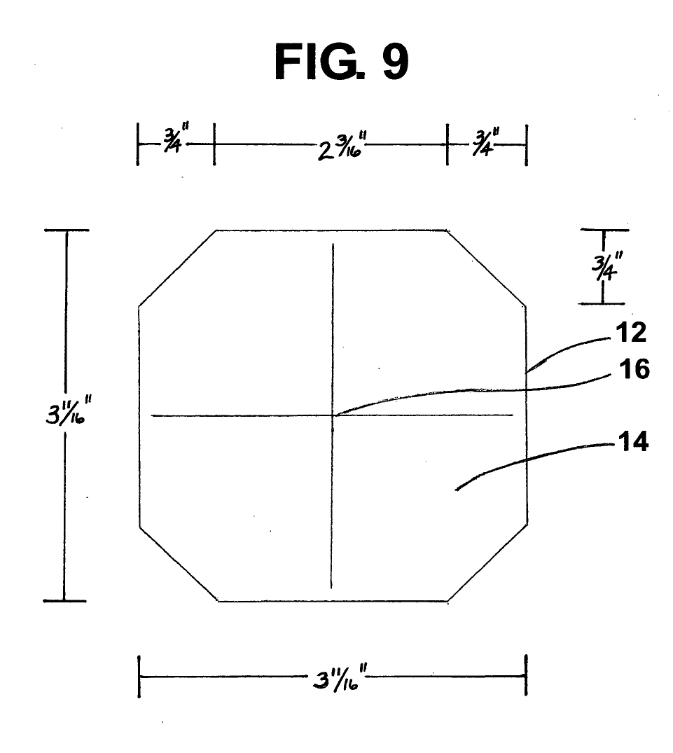

FIG. 9 is a frontal view showing the face of a template for a 4″ octagon junction box. The overall dimension of the template is 3 11/16″ tall×3 11/16″ wide× 3/32″ thick 12. It is preferably manufactured from a flat sheet 14 of transparent plastic or Plexiglas material. It has a cross hair 16 marked on the template to aid in aligning the template on the surface to be cut out.

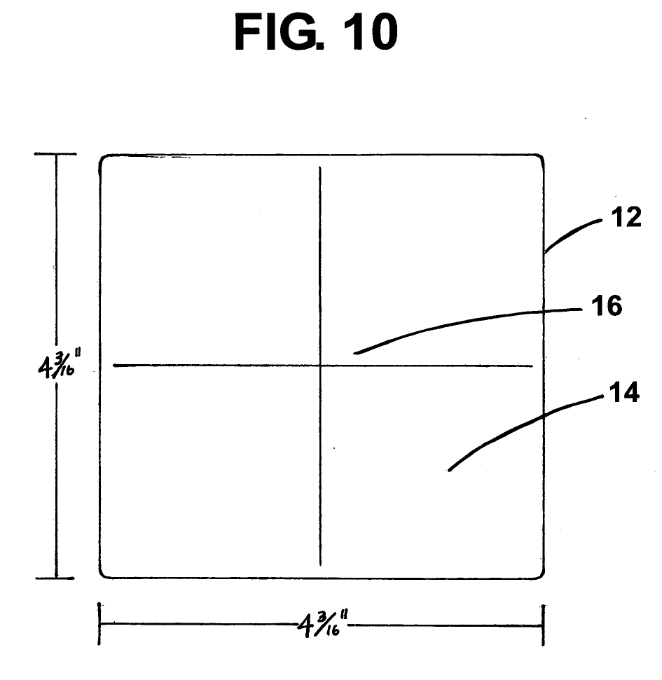

FIG. 10 is a frontal view showing the face of a template for a 4″ square junction box. The overall dimension of the template is 4 3/16″ tall×4 3/16″ wide× 3/32″ thick 12. It is preferably manufactured from a flat sheet 14 of transparent plastic or Plexiglas material. It has a cross hair 16 marked on the template to aid in aligning the template on the surface to be cut out.

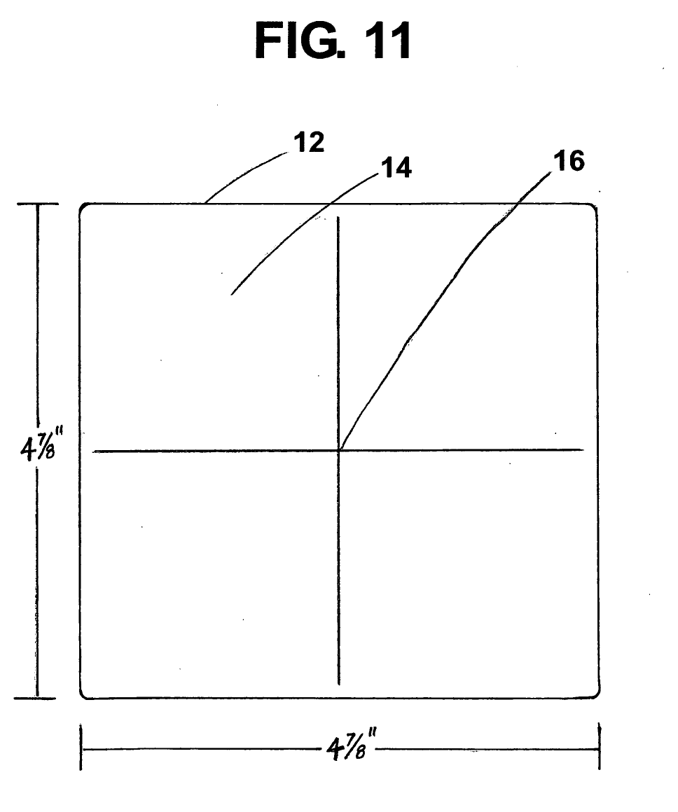

FIG. 11 is a frontal view showing the face of a template for a 4 11/16″ square junction box. The overall dimension of the template is 4⅞″ tall×4⅞″ wide× 3/32″ thick 12. It is preferably manufactured from a flat sheet 14 of transparent plastic or Plexiglas material. It has a cross hair 16 marked on the template to aid in aligning the template on the surface to be cut out.

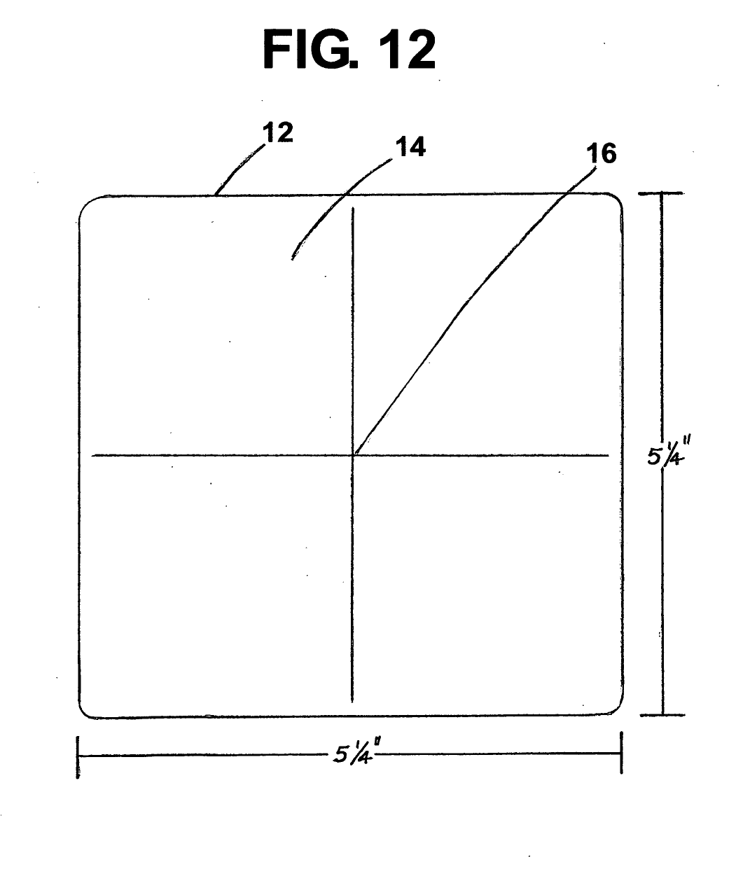

FIG. 12 is a frontal view showing the face of a template for a 5¼″ square recessed light fixture. The overall dimension of the template is 5¼″ tall×5¼″ wide× 3/32″ thick 12. It is preferably manufactured from a flat sheet 14 of transparent plastic or Plexiglas material. It has a cross hair 16 marked on the template to aid in aligning the template on the surface to be cut out.

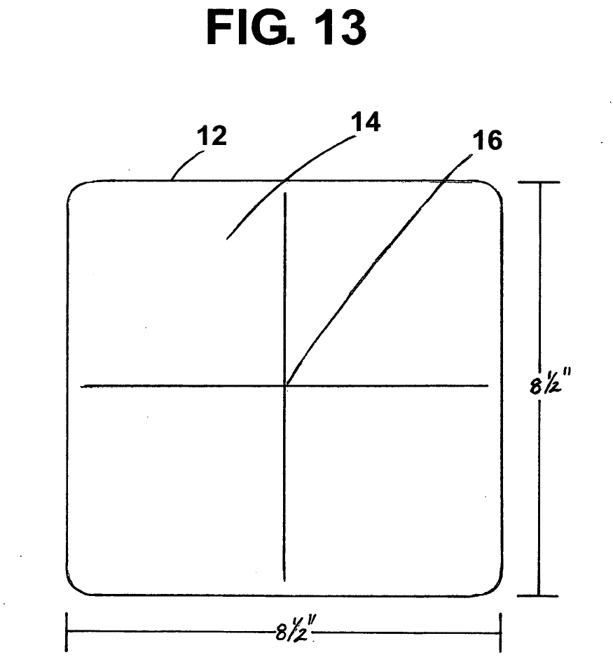

FIG. 13 is a frontal view showing the face of a template for an 8½″ square recessed light fixture opening. The overall dimension of the template is 8½″ tall×8½″ wide× 3/32″ thick 12. It is preferably manufactured from a flat sheet 14 of transparent plastic or Plexiglas material. It has a cross hair 16 marked on the template to aid in aligning the template on the surface to be cut out.

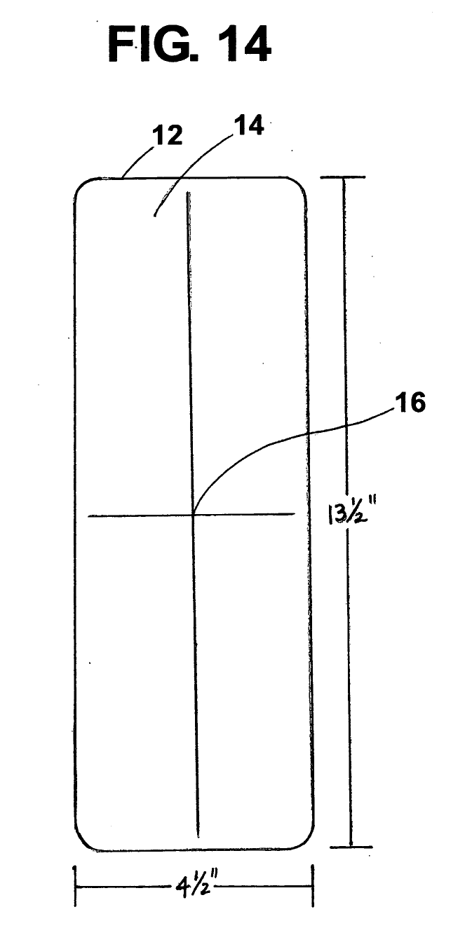

FIG. 14 is a frontal view showing the face of a template for a 4½ wide×13½″ tall exit light fixture opening. The overall dimension of the template is 4½″ wide×13½″ tall× 3/32″ thick 12. It is preferably manufactured from a flat sheet 14 of transparent plastic or Plexiglas material. It has a cross hair 16 marked on the template to aid in aligning the template on the surface to be cut out.

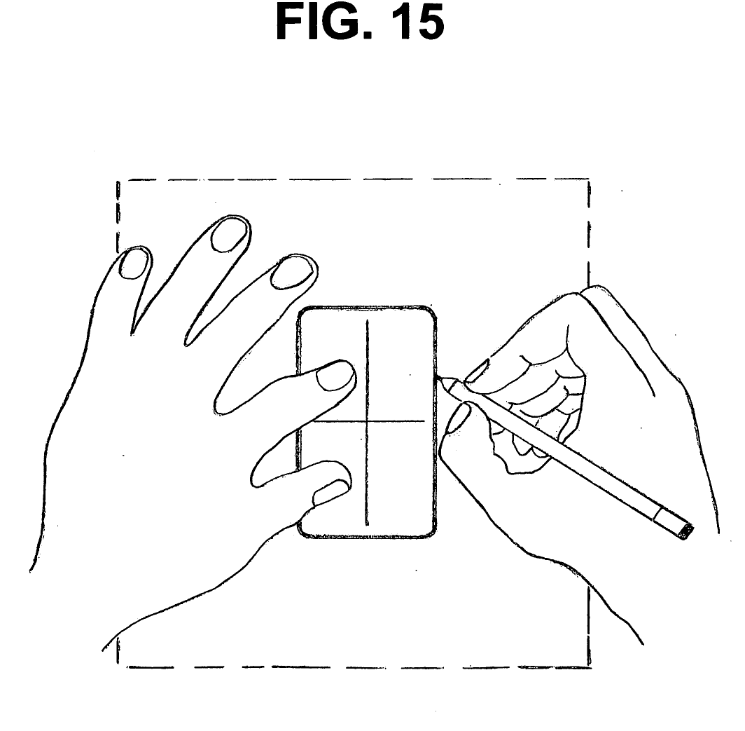

FIG. 15 is a view showing the typical manner of how a craftsman would use a template to mark or scribe the outline of a single gang box cover on a flat surface.

What I claim as my invention is:

1. A template kit consisting of a variety of individual templates used for marking or scribing the outline of electrical junction boxes, box covers, and light fixture openings on a wall, cabinet, partition, ceiling tile, or any other flat surface:
a. All of the templates in this kit are made preferably from a thin single sheet of transparent plastic or Plexiglas material that is approximately 3/32″ thick,
b. The shape of each template in this kit is unique in peripheral dimensions.
c. Each template in this kit will have either a “cross hair” or “dot” marked on the center of it to aid in aligning the template on the surface to be marked or scribed.

2. An individual template according to claim 1 specifically designed for marking or scribing the outline of a 1-gang box cover. The physical dimensions of this template are illustrated in FIG. 2.

3. An individual template according to claim 1 specifically designed for marking or scribing the outline of a 3/0 box cover. The physical dimensions of this template are illustrated in FIG. 3.

4. An individual template according to claim 1 specifically designed for marking or scribing the outline of a 2-gang box cover. The physical dimensions of this template are illustrated in FIG. 4.

5. An individual template according to claim 1 specifically designed for marking or scribing the outline of a 3-gang box cover. The physical dimensions of this template are illustrated in FIG. 5.

6. An individual template according to claim 1 specifically designed for marking or scribing the outline of a “cut in” junction box. The physical dimensions of this template are illustrated in FIG. 6.

7. An individual template according to claim 1 specifically designed for marking or scribing the outline of a “handy” junction box. The physical dimensions of this template are illustrated in FIG. 7.

8. An individual template according to claim 1 specifically designed for marking or scribing the outline of a 4″ round junction box. The physical dimensions of this template are illustrated in FIG. 8.

9. An individual template according to claim 1 specifically designed for marking or scribing the outline of a 4″ octagon junction box. The physical dimensions of this template are illustrated in FIG. 9.

10. An individual template according to claim 1 specifically designed for marking or scribing the outline of a 4″ square junction box. The physical dimensions of this template are illustrated in FIG. 10.

11. An individual template according to claim 1 specifically designed for marking or scribing the outline of a 4 11/16″ junction box. The physical dimensions of this template are illustrated in FIG. 11.

12. An individual template according to claim 1 specifically designed for marking or scribing the outline of a 5¼″ square recessed light fixture opening. The physical dimensions of this template are illustrated in FIG. 12.

13. An individual template according to claim 1 specifically designed for marking or scribing the outline of an 8½″ square recessed light fixture opening. The physical dimensions of this template are illustrated in FIG. 13.

14. An individual template according to claim 1 specifically designed for marking or scribing the outline of a 4½″×13½″ exit light fixture opening. The physical dimensions of this template are illustrated in FIG. 14.
